(19) United States
(12) Patent Application Publication
(10) Pub. No.: US 2014/0330751 A1
(43) Pub. Date: Nov. 6, 2014

(54) Method and system to capture credit risks in a portfolio context

(71) Applicants: Ferdinand Mager, Wiesbaden (DE); TILL FÖRSTEMANN, Holzminden (DE)

(72) Inventors: Ferdinand Mager, Wiesbaden (DE); TILL FÖRSTEMANN, Holzminden (DE)

(21) Appl. No.: 14/269,796

(22) Filed: May 5, 2014

(30) Foreign Application Priority Data
May 4, 2013 (DE) 10 2013 007 769.9

(51) Int. Cl. G06Q 40/02

(52) U.S. Cl. CPC G06Q 40/025; G06Q 40/06
USPC 705/36 R

(57) ABSTRACT

A method for capturing credit risks in a portfolio context includes the steps of linking accounting data of economic subjects using data on the exchange of goods and services between the economic subjects and determining the probability of at least one credit event in the portfolio context by applying at least one rating model to the accounting data of the economic subjects.

The invention relates to a method and a system to capture credit risks. The method for capturing credit risks in a portfolio context enables a precise and robust capture of relationships between credit events on the basis of supply relationships between economic subjects.

In this context, economic subjects are understood as natural and/or legal persons as well as groups of natural and/or legal persons who participate in economic life. Supply relationships are understood as the exchange of goods between economic subjects. Credit events are understood as credit defaults and any credit rating change, i.e., changes of the probability of credit defaults. Credit default is understood as any case, in which at least one debtor does not fully meet its obligations toward a creditor at at least one time point.

Current methods to capture credit risks in a portfolio context can be distinguished into two groups: Intensity based models are intended to capture statistical relationships (such as correlations) between credit defaults of borrowers directly, e. g. by using a joint probability distribution. Market based methods are intended to capture statistical relationships between changes in credit ratings of different borrowers using market prices (e. g. market prices of stocks or bonds).

Current methods to capture credit risks in a portfolio context do not capture the exchange of goods and services between economic subjects sufficiently or not at all. Consequently, they typically capture linkages between credit events that result from the exchange of goods and services only imprecisely, incomprehensively and not in a robust manner, even if they use sophisticated mathematical methods. This is one of the reasons why currently the banks' own methods to capture credit risk in a portfolio context are not accepted under the regulatory framework according to Basel II.

The invention solves this problem by a method which captures the exchange of goods and services between economic subjects directly. Consequently, it can capture a main reason for economic linkages between economic subjects in general and of linkages between credit events in particular in a precise, comprehensible and robust manner.

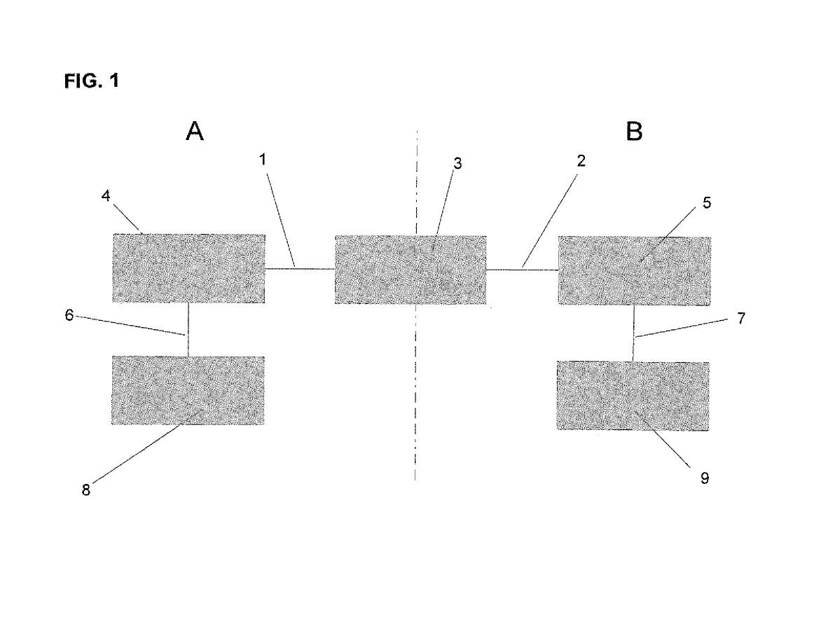

As shown in FIG. 1, the method according to the invention can include forming at least one link (1, 2) between accounting data of economic subjects (4, 5) using data on the exchange of goods and services (3).

When at least one of the economic subjects is a company, the accounting data (4, 5) may include data from a statement of financial position, an income statement and/or a statement of cash flows. When at least one of the economic subjects is a country, the accounting data (4, 5) may include data from national accounts. The accounting data (4, 5) may also contain combined ratios such as equity ratios or gross margins in the case of corporations.

At least one link (1, 2) between the accounting data of economic subjects (4, 5) using data on the exchange of goods and services (3) may be based on at least one input-output-table.

The method may use the fact that input-output-tables in the general form described by Wassily Leontief resemble an extended income statement of corporations:

The input-dimension of an input-output-table (typically in columns) may contain the data on the generation of goods and services. The statements of profit and losses of corporations can be interpreted as data on the generation of revenues. It can thus be written in the form of an input-table.

The output-dimension of an input-output-table (typically in rows) may contain data on the use of goods and services. For example, the revenues of a corporation can be recorded by customers or groups of customers.

At least one input-output-table can thus be used to link (1, 2) accounting data of economic subjects (4, 5) using data on the exchange of goods and services (3).

An example for at least one such link (1, 2) is the connection of data on the revenues of a supplier (4) with data on the costs of goods sold of a supplied company (5) using data on the exchange of goods and services (3) between those corporations. Another example for such a link (1, 2) is the connection of data on the revenues of at least one corporation resulting from the export of at least one good (4) and data on the import of this good by one or more countries (5) using data on the exchange of these goods and services (3). These relationships between different economic subjects are economically comprehensible and robust and easily verifiable.

Furthermore, the method may capture at least one probability of at least one credit default of at least one economic subject (8, 9) applying at least one rating model (6, 7) to accounting data of at least one economic subject (4, 5). Such determination of the creditworthiness of economic subjects from accounting data of these economic subjects are widely used in the risk management of banks. Many internal rating models (6, 7) of banks have already been accepted under Basel II by supervisory authorities.

To summarize, the method may capture the probability of at least one credit event of at least two economic subjects (8, 9) in a portfolio context. As shown in FIG. 1 it may include forming a link (1, 2) between accounting data of at least two economic subjects (4, 5) using data on the exchange of goods and services (3). It may also include deriving the probability of at least one credit event from the accounting data of economic subjects.

This systematic approach to measure the risk of a credit portfolio on the basis of forming a link (1, 2) between accounting data of economic subjects (4, 5) by using data on the exchange of goods and services (3) is new. It allows precisely capturing even complex non-linear relationships between credit events, for example when a decline of demand for a final product of a company has an effect along the supply-chain on the solvency of all supply companies in the portfolio of a creditor, wherein this effect strongly differs however depending on the capitalization of the corporations prior to the decline.

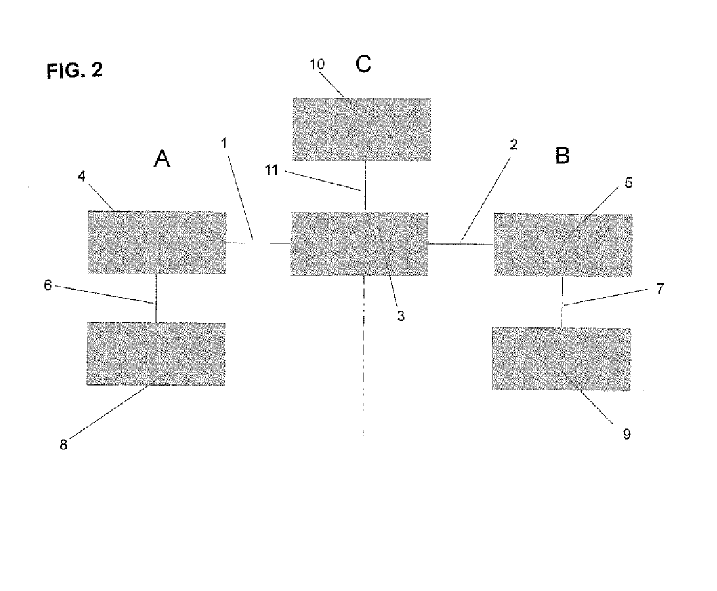

FIG. 2 explains the basic idea behind the invention using the example of three economic subjects A, B and C. It shows how the method can be applied to more than two economic subjects.

The German company A may produce catalytic converters for the German car manufacturer B which sells its products exclusively to the United States as economic subject C.

When the demand for automobiles in the United States declines, car manufacturer B will sell fewer cars. It needs fewer catalytic converters such that company A will also be affected from the decline of demand for cars in the United States. The credit quality of company A will decline even if it supplies only one German company.

If both companies A and B are clients of the same bank, it is important for this bank to capture linkages between the credit qualities of both clients. In the example, the bank should know that the credit qualities of both clients move in sync mainly driven by the demand for cars in the United States. If the latter decreases, both clients of the banks will be adversely affected.

As shown in FIG. 2, the new method can. provide the bank with this information by forming a link (1, 2, 11) between the accounting data of company A (4), the accounting data of company B (5) and accounting data of the United States (10) using data on the exchange of goods and services (3).

In the example, the costs of goods sold in the income statement of company B can be linked with the revenues in the income statement of company A and the demand for cars in the United States may be linked with the revenues of company B. Forming these links (1, 2, 11) between accounting data of economic subjects (4, 5, 10) using data on the exchange of goods and services (3) may be implemented in the form of input-output-tables. Consequently, it is for example possible to capture how the demand for cars in the United States affects revenues and other accounting data of the companies A and B (4, 5). And using at feast one rating model (6, 7) the accounting data of both companies (4, 5) can be used to derive the resulting probabilities of a credit event of companies A and B (8, 9).

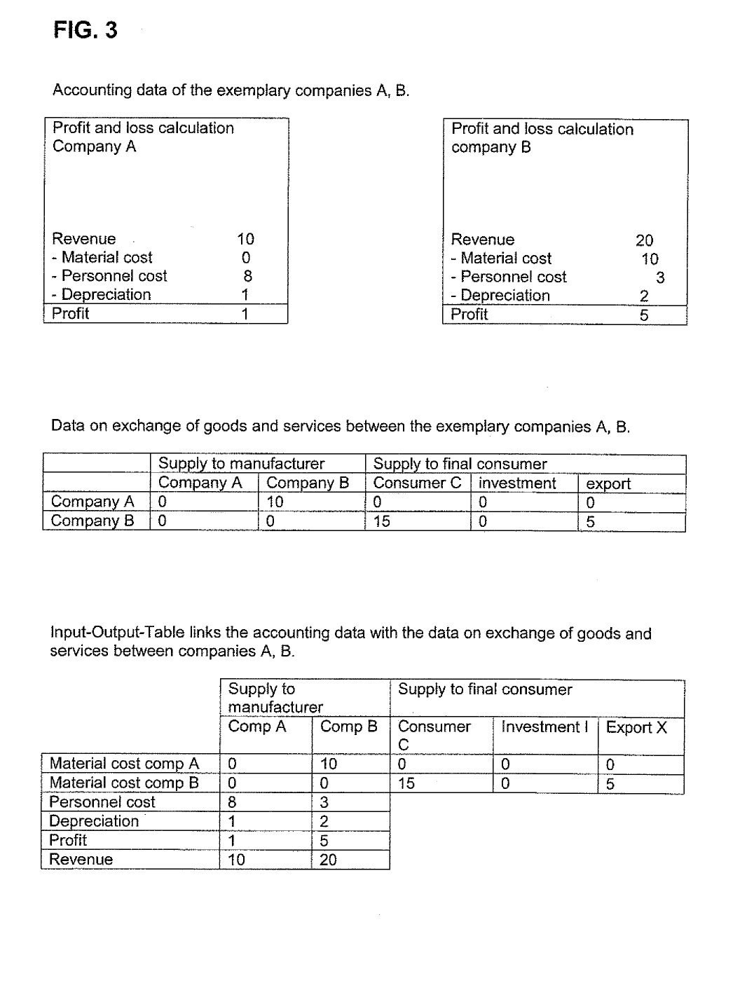

FIG. 3 exemplifies, how an input-output-table can be used to form a link (1, 2) between accounting data of two companies (4, 5) using data on the exchange of goods and services (3).

The upper part of FIG. 3 shows two stylized income statements as accounting data of two companies A, B. Company A may produce agricultural products, company B may process these goods. Both companies may be the only companies in a small economy.

The middle part of FIG. 3 shows data on the exchange of goods and services between both companies. In the example, company A may exclusively supply company B. Thus the revenue of 10 in the income statement of company B is part of the costs of goods sold in the income statement of company B. Company B may sell its goods to consumers only, 15 of its revenue are attributable to consumers its home country and 5 to consumers in a foreign country. The revenues of both companies are thus generated as shown in the middle of FIG. 3.

The lower part of FIG. 3 shows how the data on the exchange of goods and services can be combined with the income and loss statement in an input-output-calculation. For this, revenues are written from the first line of the income statement to the bottom line of the input-table and the costs of goods are itemized according to suppliers using the data on the exchange of goods and services. The resulting input-output-table thus links accounting data of economic subjects using data on the exchange of goods and services.

Using such linkages, the consequences of economic scenarios for a multitude of economic subjects can be estimated simultaneously.

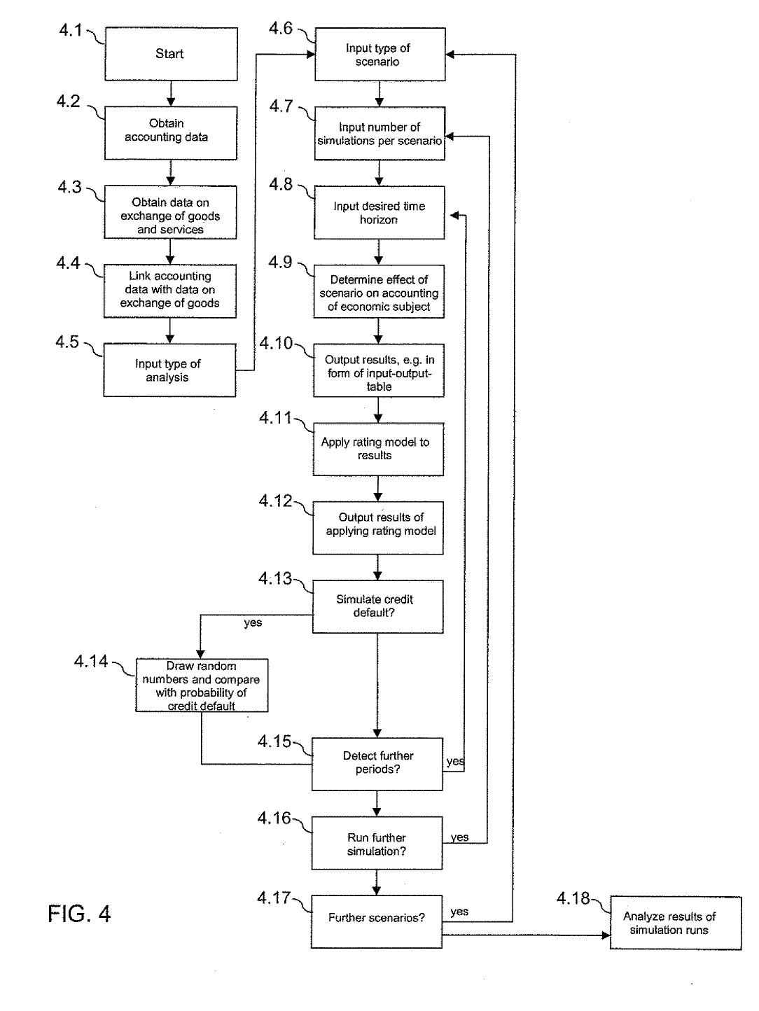

FIG. 4 illustrates an exemplary embodiment of the invention. In this case the method is executed automatically within a computer system, i.e., is implemented by a computer. The method steps are implemented as far as possible as automatically executed steps of a processor of the computer system.

After the start (4.1) of the method, accounting data of economic subjects can be entered (4.2), for example manually or using a dataset. Data on the exchange of goods and services between economic subjects can also be entered (4.3). In the next step (4.4), the data on the exchange of goods and services can be linked with the accounting data of economic subjects. This can be implemented for example in the form of input-output-tables. In the following step (4.5) additional data for the subsequent analyses can be entered, for example the type of desired analysis, the scenarios, as well as the number of runs and/or the time horizon of the following simulation.

At the beginning of the first loop (4.6) the scenarios to be analyzed can be entered. This input may be given manually or using a dataset. Also, at the beginning of the second loop (4.7) the desired number of runs of the simulation per scenario may be entered. Taking into account that the economic consequences of one scenario may be mostly stochastic, it may typically make sense to run more than one simulation per scenario. The simulation of several possible paths per scenario allows estimating the probabilities of possible outcomes. In the next step (4.8) the time horizon of the analysis per simulation can be entered.

In the next step (4.9), the economic consequences of a scenario on the accounting data of the economic subjects can be captured. For example, data on the exchange of goods and services can be used to analyze how the accounting data of the borrowers in the portfolio of a creditor change in a scenario in which sales of automobiles in the United States decline by a certain percentage at a certain time point of a certain simulation run. In the following step (4.10) the results can be outputted, for example in the form of simulated input-output-tables.

Using at least one credit rating model, the outputted result may be used to estimate (4.11) and output (4.12) the probability of at least one credit event and its economic consequences for at least one lender. The economic consequences for the at least one lender may be measured as a loss given default (LGD).

In another input (4.13) it can be entered, whether credit defaults are to be simulated. If this is the case, random numbers can be drawn and compared to the estimated probabilities of default. If a random number is smaller than the estimated probability of default, the according credit is considered to have defaulted in this scenario, period and run.

At the end of the third loop (4.15) it can be checked whether additional periods are to be simulated. If this is the case, the method can be continued at point (4.8).

At the end of the second loop (4.16) it can be checked whether an additional run is to be simulated. If this is the case, the method can be continued at point (4.7).

At the end of the first loop (4.17) it can be checked whether an additional scenario is to be simulated. If this is the case, the method can be continued at point (4.6).

Otherwise, the results of the simulation can be analyzed (4.18). For example, a loss distribution function can be estimated, which might be used to calculate common measures of portfolio risk such as Value at Risk (VaR) and/or Expected Shortfall (ES). The results from the simulation can also be used to derive matrices containing rating migrations. The results for at least one single scenario can be considered for example in the context of (portfolio) stress tests.

What is claimed is:

1-11. (canceled)

12. A method of capturing credit risks in a portfolio context, comprising:
linking accounting data of at least two economic subjects by using data on the exchange of goods and services between the at least two economic subjects; and
determining a probability of at least one credit event in a portfolio context by applying at least one credit rating model to the accounting data.

13. The method of claim 12, wherein the accounting data of the economic subjects are linked using data on the exchange of goods and services in the form of at least one input-output-table, according to the basic concept of Wassily Leontief.

14. The method of claim 12, wherein the accounting data of the economic subjects comprise data from at least one income statement of at least one company.

15. The method of claim 12, wherein data on the exchange of goods and services between economic subjects comprise data on the source of revenue of at least one company by a customer.

16. The method of claim 12, further comprising simulating the accounting data of the at least one economic subject in at least one simulation run based on at least one economic scenario.

17. The method of claim 16, further comprising capturing an associated probability of credit events in the portfolio context by applying the at least one rating model to the simulated accounting data of the at least one economic subject.

18. The method of claim 17, further comprising simulating credit defaults by using at least one probability of credit events in the portfolio context in the at the least one scenario, the at least one simulation run and at the least one time point.

19. The method of claim 17, further comprising estimating at least one migration matrix, which contains at least one probability of a change of a credit rating from at least one class to at least one other class.

20. The method of claim 18, wherein the credit defaults simulated in the at least one scenario, the at least one simulation run and the at least one time point are used in the portfolio context to capture at least one loss distribution function or at least one of a value at risk and expected shortfall.

21. A computer readable storage medium, comprising computer-implemented instructions for performing the method of claim 1.

22. A system for analyzing credit risks in a portfolio context, the system characterized by comprising a computer system with a computer memory which is communicatively coupled to a computer processor, wherein the computer memory comprises instructions which cause the computer processor to perform a method to capture credit risks in a portfolio context according to claim 1.
